(19) United States
(12) Patent Application Publication
(10) Pub. No.: US 2022/0350552 A1
(43) Pub. Date: Nov. 3, 2022

(54) PRINT SETTINGS DETERMINATION

(71) Applicant: HEWLETT-PACKARD DEVELOPMENT COMPANY, L.P., Houston, TX (US)

(72) Inventors: . ANUSHA, Bangalore (IN); Devi VELLINGIRI, Bangalore (IN); Puviyarasu VELUMANI, Bangalore (IN)

(73) Assignee: HEWLETT-PACKARD DEVELOPMENT COMPANY, L.P., Spring, TX (US)

(21) Appl. No.: 17/773,343

(22) PCT Filed: Aug. 27, 2020
(86) PCT No.: PCT/US2020/048106

§ 371 Date: Apr. 29, 2022

(30) Foreign Application Priority Data
Oct. 31, 2019 (IN) 201941044219

(51) Int. Cl. G06F 3/12

(52) U.S. Cl. CPC G06F 3/1254; G06F 3/1205; G06F 3/1204

(57) ABSTRACT

Techniques for determining print settings of a source document are described. In an example, a scanned copy of a source document is obtained. The scanned copy of the source document is then analyzed to obtain print parameters associated with the source document, where the print parameters indicate print settings used to print the source document. A document may then be caused to be printed on a print media based on the print parameters.

### BACKGROUND

Imaging devices are commonly used to print documents on a print media to obtain a printed document. Imaging devices also facilitate in creation of digital copies of the printed document by scanning the printed document.

### BRIEF DESCRIPTION OF DRAWINGS

FIG. 1 illustrates a system for determining print settings of a source document, in accordance with an example implementation of the present subject matter,

FIG. 2 illustrates a system for determining print settings of a source document, in accordance with another example implementation of the present subject matter,

FIG. 3 illustrates a method for determining print settings of a source document, in accordance with an example implementation of the present subject matter, and

FIG. 4 illustrates a method for determining print settings of a source document, in accordance with another example implementation of the present subject matter.

### DETAILED DESCRIPTION

To print a document in a specific format, an imaging device is usually configured with print settings. For instance, while printing the document, print parameters, such as page margins, font size and colour, and paper size may be specified by a user and the document may then be printed based on specified print settings.

Generally, when a document is printed, the print parameters are specified by the user. Sometimes, based on user preferences, the print parameters are stored for future utilization and printing of documents. In some situations, a user may try to configure the imaging device with print settings of an already printed document. That is, the user may wish to use print parameters for a document that are similar to that of the already printed document. In such situations, to achieve the print setting of the already printed document, the user may perform manual approximations of print parameters of the source document, such as font, size, colour and margins, and provide the approximate values to the imaging device. For the ease of reference, such printed document from which the print settings are identified, is referred to as a source document, hereinafter.

Determination of print parameters from a source document is complex and tedious, and approximation of print parameters does not produce accurate print results.

According to example implementations of the present subject matter, techniques for determining print settings of a source document are described.

In an example, a computing system may first obtain a scanned copy of a source document. The computing system may then analyze the scanned copy to identify print settings used to print the source document. Based on the analysis, the computing system may determine multiple print parameters associated with the source document. The print parameters are indicative of the print settings used to print the source document. Examples of print parameters may include, but are not limited to, font type, font size, page margins, colour settings, page size, and page orientation. The computing system may subsequently generate a print template based on the identification of the print parameters. A document may then be printed based on the print template.

In another example, the computing system may also allow the print parameters to be modified based on a user input, a state of the imaging device, or a combination thereof. Once modified, the document may be printed based on modified print parameters.

The identification of the print parameters based on the analysis of the scanned copy of the source document avoids the repeated approximations associated with the identification of the print parameters from the source document. This, in turn, reduces the complexity and tediousness involved in the determination of the print settings of the source document. Thus, the techniques disclosed in the present subject matter facilitate printing of the document based on the print settings of the source document without specifying the individual print parameters associated with the source document.

While the techniques discussed above has been specifically explained for determination of the print settings of the source document from the scanned copy of the source document, the techniques are not limited to determination of the print settings from the scanned copy and may also be used to determine the print settings of the source document using other printed formats such as, an image of the source document.

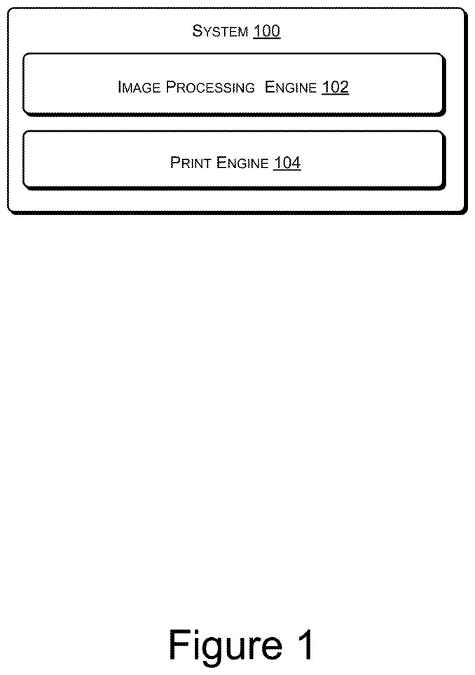

The above techniques are further described with reference to FIG. 1 to FIG. 4. It should be noted that the description and the figures merely illustrate the principles of the present subject matter along with examples described herein, and should not be construed as a limitation to the present subject matter. It is, thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a system 100, in accordance with an example implementation of the present subject matter. Examples of the system 100 may include, but are not limited to, laptops, desktops, smartphones, tablets, and personal digital assistants (PDAs). Examples of the system 100 may also include imaging devices including, but are not limited to, scanners, multi-function printers, and fax machines.

The system 100 may include an image processing engine 102 to analyse a scanned copy of a source document and determine print settings of source document. Specifically, the image processing engine 102 may analyse the scanned copy of the source document to determine print parameters associated with the source document, where the print parameters indicate the print settings used to print the source document. Examples of print parameters may include, but are not limited to, font size, page margins, colour settings, page orientation, page size, and a mode of printing including a simplex mode and a duplex mode.

In an example, the image processing engine 102 may be implemented as a combination of hardware and firmware. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions. In the present examples, the machine-readable storage medium may store instructions that, when executed by the processing resource, implement the functionalities of the engine. In such examples, the system 100 may include the machine-readable storage medium storing the instructions and the processing resource to execute the instructions. In other examples of the present subject matter, the machine-readable storage medium may be located at a different location but accessible to system 100 and the processing resource.

The system 100 may further include a print engine 104. In the example, the print engine 104 may also be implemented as a combination of hardware and firmware. In an example, the print engine 104 may be coupled to the image processing engine 102. The print engine 104 may receive print parameters from the image processing engine 102 and based on the received print parameters, the print engine 104 may cause a document to be printed on a print media.

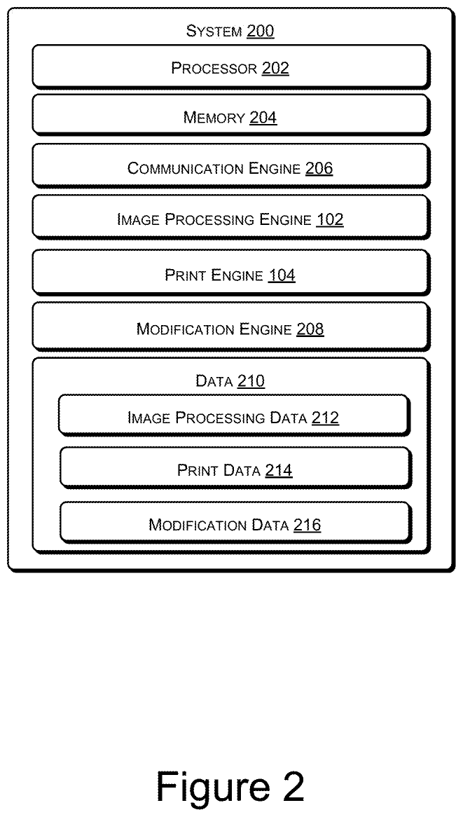

FIG. 2 illustrates a system 200, in accordance with another example implementation of the present subject matter. The system 200 may include a processor 202 and a memory 204 coupled to the processor 202.

The functions of the various elements shown in the Figures, including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included.

The memory 204 may include any computer-readable medium including, for example, volatile memory (e.g., RAM), and/or non-volatile memory (e.g., EPROM, flash memory, etc.).

The system 200 may also include a communication engine 206, an image processing engine 102 coupled to the communication engine 206, a print engine 104 coupled to the image processing engine 102, and a modification engine 208 coupled to the print engine 104. In an example, the communication engine 206, the image processing engine 102, the print engine 104, and the modification engine 208 may be implemented as a combination of hardware and firmware. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions. In the present examples, the machine-readable storage medium may store instructions that, when executed by the processing resource, implement the functionalities of the engine. In such examples, the system 200 may include the machine-readable storage medium storing the instructions and the processing resource to execute the instructions. In other examples of the present subject matter, the machine-readable storage medium may be located at a different location but accessible to system 200 and the processing resource.

The system 200 may further include data 210, that serves, amongst other things, as a repository for storing data that may be fetched, processed, received, or generated by the communication engine 206, the print engine, and the modification engine. The data 210 may include image processing data 212, print data 214, and modification data 216. In an example, the data 210 may be stored in the memory 204.

In operation, the communication engine 206 may obtain a scanned copy of a source document. The communication engine 206 may obtain the scanned copy of the source document from multiple sources. In an example, the communication engine 206 may obtain the scanned copy of the source document from an imaging device (not shown) coupled to the system 200. In another example, the communication engine 206 may obtain a digital copy of the source document from the memory 204.

In an example implementation of the present subject matter, the image processing engine 102 may receive the scanned copy of the source document from the communication engine 206. The image processing engine 102 may then analyze the scanned copy of the source document to identify print parameters associated with the source document, where the print parameters indicate the print settings used to print the source document. Examples of print parameters may include, but are not limited to, font type, font size, page margins, colour settings, page orientation, page size, and a mode of printing.

In an example, the image processing engine 102 may determine the page size of the source document. The image processing engine 102 may determine the page size of the source document in different ways.

In an example, the communication engine 206 may obtained the scanned copy of the source document from the imaging device. In such situation, details indicating the page size may be determined by the imaging device and may be provided with the scanned copy of the source document. In the example, the image processing engine 102 may determine the page size by extracting the details from the scanned copy of the source document.

In another example, the image processing engine 102 may determine the page size based on a ratio of a longitudinal edge to a vertical edge of the source document. For instance, a document having the ratio of 1^{1/2}:1 may be determined to be of A4 size. Similarly, a document having the ratio of 2:1^{1/2} may be determined to be of A3 size.

In an example of the present subject matter, the image processing engine 102 may also determine the page margins, font type, and font size associated with the source document. In an example, the image processing engine 102 may perform optical character recognition (OCR) on the scanned copy of the source document. In operation, the image processing engine 102 may analyze the document for light and dark areas. Based on the analysis, the image processing engine 102 may identify the dark areas as characters and light areas as blank spaces. In an example, the light areas in the source document may indicate the presence of blank space and the dark areas may indicate the presence of a word or an image in the source document.

Subsequently, the image processing engine 102 may ignore the light areas and further process the dark areas for identification of the aforementioned print parameters. Specifically, the image processing engine 102 may identify a bounding box for each dark area, where the bounding box indicates the x-y coordinates of the dark area in the source document. The image processing engine 102 may then analyze the x-y coordinates of all the dark areas within the source document and may identify the lowest value of the x-coordinate. Based on the lowest value of the x-coordinate, the image processing engine 102 may determine a left margin of the source document.

Similarly, the image processing engine may identify a top margin, a right margin, and a bottom margin of the source document based on the analysis of the x-y coordinates of the bounding boxes within the source document.

The image processing engine 102 may also determine the page orientation of the source document. In an example, a default page orientation of the source document may be portrait. The image processing engine 102 may determine a change in the page orientation of the source document based on a ratio of the height and width of a word. Specifically, as the image processing engine 102 may identify the dark areas within the source document to be the words, the image processing engine 102 may first identify the x-y coordinates of the words present within the source document. Based on the identified x-y coordinates, the image processing engine 102 may calculate the height and width of the words present within the source document. Accordingly, if the ratio is determined to be greater than 1, the image processing engine may identify that the words have been rotated by 90 degrees. In such a situation, the image processing engine 102 may determine the page orientation to be landscape.

The image processing engine 102 may further process the dark areas to identify the font type and font size of the characters present therein. Specifically, the image processing engine 102 may process the dark areas to identify features such as, angles, curves, or crosses associated with the characters. The image processing engine 102 may then compare the identified features with a set of characters stored in a library of characters to identify the font type and the font size. In an example, the library may include multiple characters in different font types and font sizes. The library may be an online library or may be stored locally on the system 200. Based on the comparison, the image processing engine 102 may identify the font type and font size of the characters present within the source document.

The image processing engine 102 may also determine the mode of printing of the source document. In an example, the image processing engine 102 may determine the mode of printing to be one of simplex and duplex. The mode of printing may be determined in different ways.

In an example, the communication engine 206 may obtain the scanned copy of the source document from the imaging device. In such situation, details indicating the mode of printing may be determined automatically by the imaging device and may be included with the scanned copy of the source document. Thus, the image processing engine 102 may determine the mode of printing by extracting the details from the scanned copy of the source document.

In another example, the image processing engine 102 may determine the mode of printing of the source document by analysing both sides of the source document. Specifically, the image processing engine 102 may perform OCR on both sides of the source document and identify the presence of the dark areas. Based on the presence of the dark areas, the image processing engine 102 may determine the mode of printing to be simplex or duplex.

The image processing engine 102 may further determine the colour settings of the source document. The image processing engine 102 may determine the colour settings of the source document in different ways. In an example, the image processing engine 102 may determine RGB values of a series of pixels of the scanned copy of the source document. Based on the determined RGB values, the image processing engine 102 may determine the colour settings of the source document. For instance, if the RGB value is same for the series of pixels, the image processing engine 102 may determine the colour settings to be monochrome. On the other hand, the image processing engine 102 may determine the colour settings of the source document based on the RGB values of the series of pixels.

The image processing engine 102 may then store the print parameters associated with the source document in the image processing data 212. In an example, the image processing data 212, may serve, amongst other things, as a repository for storing data that may be fetched, processed, received, or generated by the image processing engine 102.

The print engine 104 may then access the print parameters from the image processing data 212. Based on the print parameters, the print engine 104 may generate a print template to print the document. Based on the print template, the print engine 104 may cause the document to be printed. The print engine 104 may then store the print template in the print data 214. In an example, the print data 214, serves, amongst other things, as a repository for storing data that may be fetched, processed, received, or generated by the print engine 104.

In an example of the present subject matter, the print parameters may be modified by the modification engine 208 before utilization for printing the document. In an example, the modification engine 208 may modify the print parameters based on a number of factors.

In an example, the modification engine 208 may modify the print parameters based on a user input. Specifically, the modification engine 208 may display and receive the user input to modify the print parameters. For instance, the modification engine 208 may display the page size of the source document to be A4 and may allow the user to modify the page size to be ‘A3’ or ‘Letter’.

Similarly, the modification engine 208 may allow the user to modify other print parameters, such as the font type and the font size, the page orientation, the page margins, and the colour settings. The modification engine 208 may then store modified print parameters in modification data 216. The modification data 216, serves, amongst other things, as a repository for storing data that may be fetched, processed, received, or generated by the modification engine 208.

The print engine 104 may then access the modified print parameters from the modification data 216. Based on the modified print parameters, the print engine 104 may generate a print template and print the document using the print template. The print engine 104 may then store the print template in the print data 214.

In another example, the modification engine 208 may modify the print parameters based on a state of the imaging device. The state of the imaging device may be determined based on a type of toner, a level of ink in the toner, or a combination thereof. For instance, there may be an imaging device that may have a monochrome toner. In such a situation, if the image processing engine 102 determines the colour settings of the source document to be colour, the modification engine 208 may modify the print parameter indicating the colour settings to be monochrome. Accordingly, the print engine 104 may cause the document to be printed in monochrome. In another instance, there may be an imaging device that may have a colour toner, where the toner level of the imaging device may be low. In such a situation too, the modification engine 208 may modify the print parameter indicating the colour settings to monochrome to provide quality prints while using the limited resources of the imaging devices.

Similarly, the modification engine 208 may modify the print parameters based on a number of the pages present in a tray of the imaging device. For instance, the print parameter indicating the page size may indicate the page size to be A4. There may be situation where the tray having the A4 size pages may be low on the number of pages. In such a situation, the modification engine 208 may identify a page size similar to the size of A4 pages. Accordingly, the modification engine 208 may modify the print parameter indicating the page size. The modification engine 208 may then store modified print parameters in the modification data 216. The print engine 104 may then access the modified print parameters from the modification data 216. Based on the modified print parameters, the print engine 104 may generate a print template and may cause the document to be printed using the print template.

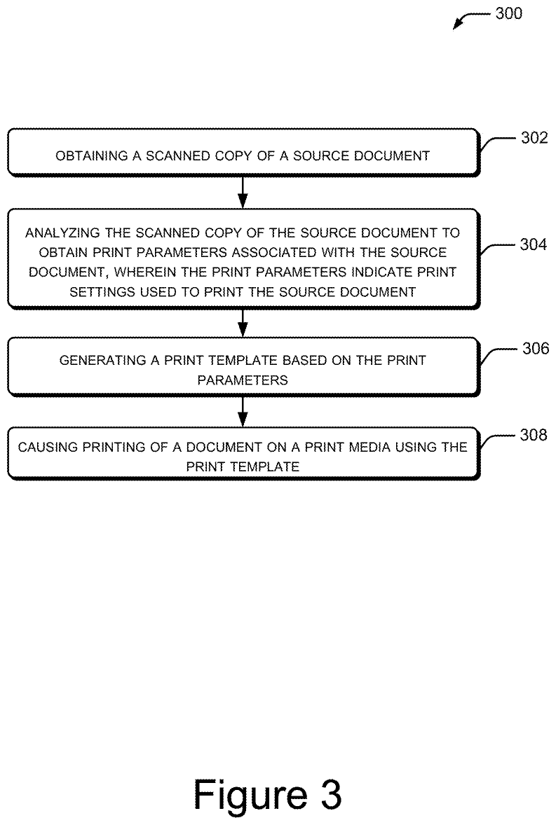

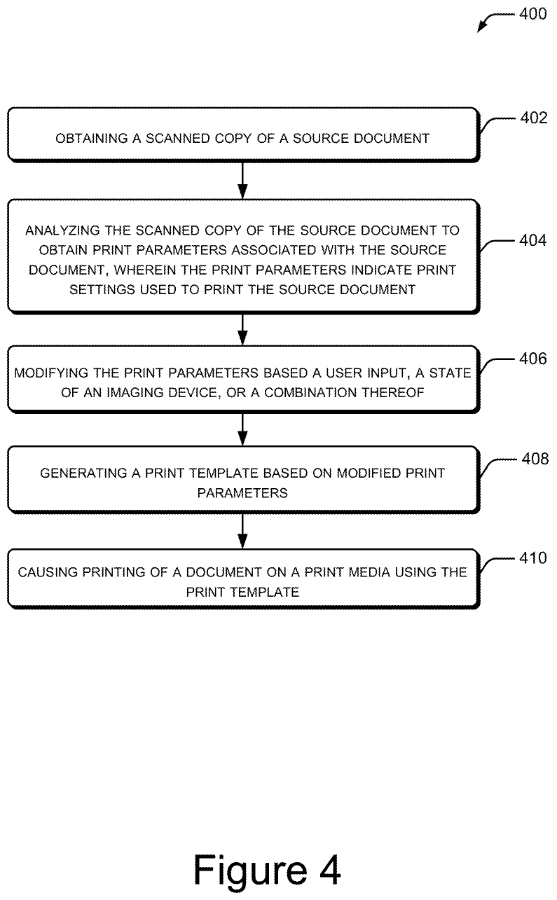

FIG. 3 and FIG. 4 illustrate methods 300 and 400 for providing determining the print settings of a source document, in accordance with examples of the present subject matter. Although the method 300 and 400 may be implemented in a variety of electronic pens, but for the ease of explanation, the description of the methods 300 and 400 is provided in reference to the above-described system 200. The order in which the methods 300 and 400 are described is not intended to be construed as a limitation, and any number of the described method blocks may be combined in any order to implement the method 300 and 400, or an alternative method.

It may be understood that blocks of the methods 300 and 400 may be performed in the system 200. The blocks of the methods 300 and 400 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 302, a scanned copy of a source document is obtained. In an example, the scanned copy of the source document is obtained by a communication engine 206 of the system 200. The communication engine 206 may obtain the scanned copy of the source document from different sources. In an example, the communication engine 206 obtains the scanned copy of the source document from a memory 204 of the system 200. In another example, the communication engine 206 obtains the scanned copy of the source document from an imaging device (not shown) coupled to the system 200.

At block 304, the scanned copy of the source document may be analyzed to obtain print parameters associated with the source document, where the print parameters indicate the print settings used to print the source document. Examples of print parameters include, but are not limited to, font size, page margins, colour settings, page orientation, and a mode of printing. In an example, an image processing engine 102 may obtain the print parameters of the source document.

At block 306, a print template may be generated based on the print parameters. In an example, a print engine 104 generates the print template of the source document. The print template may be a print setting dialog box indicating the print parameters used to print the source document. In an illustrative example, if the source document was printed on an A4 size page with font type ‘Arial’ and font size ‘10’, the print template would include three text fields indicating the page size, the font type and the font size. In such situation, the text fields for the page size, the font type and the font size would indicate A4, Arial, and 10 respectively.

At block 308, a document is caused to be printed on a print media using the print template. In an example, a print engine 104 of the system 200 causes the document to be printed using the print template. In the aforementioned illustrative example, the document would be printed on an A4 size page with font type and font size as ‘Arial’ and ‘10’ respectively.

FIG. 4 illustrates a method 400 for determining the print settings of a source document, in accordance with another example of the present subject matter.

At block 402, a scanned copy of a source document is obtained. In an example, a communication engine 206 of the system 200 obtains the scanned copy of the source document.

At block 404, the scanned copy of the source document is analyzed to obtain print parameters associated with the source document, where the print parameters indicate print settings used to print the source document. In an example, an image processing engine 102 of the system 200 analyzes the scanned copy of the source document to obtain the print parameters.

At block 406, the print parameters are modified. The print parameters may be modified based on at least one of a user input and a state of an imaging device (not shown) coupled to the system 200. In an example, a modification engine 208 of the system 200 facilitates the modification of the print parameters. In an illustrative example, the source document may be printed on a A3 size page, with top and left margins of 4 cm, and bottom and right margins of 3 cm. Further, font on the source document may be printed with a font type of ‘Times New Roman’ and a font size of ‘12’. Also, the source document may be printed in grayscale. In the illustrative example, before a document is printed based on the above-mentioned print settings, the print settings may be modified based on the user input. Specifically, a user may wish to print the document on an A4 size page with top and left margins of 3 cm, and bottom and right margins of 2 cm while retaining the other print parameters of the source document. Accordingly, the modification engine 208 may allow the print parameters to be modified to print the document on an A4 size page with top and left margins of 3 cm, and bottom and right margins of 2 cm while retaining the other print parameters of the source document.

At block 408, a document is caused to be printed on a print media based on modified print parameters. In an example, a print engine 104 causes the document to be printed based on the modified print parameters. In the example, the print engine 104 may generate a print template based on the modified print parameters. The document may then be printed based on the print template.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
obtaining a scanned copy of a source document;
analyzing the scanned copy of the source document to obtain print parameters associated with the source document, wherein the print parameters indicates print settings used to print the source document;
generating a print template based on the print parameters; and
causing printing of a document on a print media based on the print template.

2. The method as claimed in claim 1, wherein the print parameters comprise font size, page margins, colour settings, page orientation, or a combination thereof.

3. The method as claimed in claim 2, wherein the print parameters further comprise a mode of printing the source document, wherein the mode of printing is one of a simplex and a duplex mode.

4. The method as claimed in claim 1, further comprising:
modifying the print parameters based on a user input; and
printing another document based on modified print parameters.

5. The method as claimed in claim 4, wherein the print parameters are modified based a state of an imaging device.

6. The method as claimed in claim 5, wherein the state of the imaging device is determined based on a type of a toner of the imaging device, a level of ink in the toner, or a combination thereof.

7. The method as claimed in claim 6, further comprising printing the document in monochrome based on detecting a low level of ink in the toner.

8. The method as claimed in claim 4, further comprising storing the print template.

9. A system comprising:
an image processing engine to:
analyze a scanned copy of a source document; and
determine print parameters associated with the source document, wherein the print parameters indicate print settings of the source document; and
a print engine to cause to print a document on a print media based on the print parameters.

10. The system as claimed in claim in claim 9, wherein the image processing engine is to generate a print template based on the determined print parameters, and wherein the print template is used for printing another document.

11. The system as claimed in claim 9, further comprises a modification engine to modify the print parameters.

12. The system as claimed in claim 11, wherein the modification engine modifies the print parameters based on a user input, a state of an imaging device, or a combination thereof.

13. The system as claimed in claim 9, wherein the print parameters comprise font size, page margins, colour settings, page orientation, or a combination thereof.

14. A method comprising:
obtaining a scanned copy of a source document;
analyzing the scanned copy of the source document to obtain print parameters associated with the source document, wherein the print parameters indicates print settings used to print the source document;
modifying the print parameters based on a user input, a state of an imaging device, or a combination thereof; and
causing printing of a document on a print media based on modified print parameters.

15. The method as claimed in claim 14, further comprising selecting a size of the print media based on a size of the source document.
